(19) United States
(12) Patent Application Publication
(10) Pub. No.: US 2022/0275527 A1
(43) Pub. Date: Sep. 1, 2022

(54) Metal Recovery From Lead Containing Electrolytes

(71) Applicant: Aqua Metals Inc., McCarran, NV (US)

(72) Inventors: Samaresh Mohanta, Dublin, CA (US); Joshua Reill, Sparks, NV (US); Benjamin Sol Taecker, Reno, NV (US); Jeffery Hoke, Sparks, NV (US); Brian James Dougherty, Emeryville, CA (US); Jiaqi Liao, Hayward, CA (US)

(73) Assignee: Aqua Metals Inc., McCarran, NV (US)

(21) Appl. No.: 17/631,844

(22) PCT Filed: Jul. 28, 2020
(86) PCT No.: PCT/US2020/043835

§ 371 Date: Jan. 31, 2022

Related U.S. Application Data
(60) Provisional application No. 62/881,743, filed on Aug. 1, 2019.

(51) Int. Cl. C25C 1/18; C25C 7/02

(52) U.S. Cl. CPC C25C 1/18; C25C 7/02

(57) ABSTRACT

Valuable metals, and especially copper and silver, are recovered from a lead containing electrolyte in a process in which the electrolyte is fed into an electrochemical polishing reactor that has a high-surface area cathode at which the electrode potential is controlled to so preferentially reduce copper and silver and to form a pre-treated lead-enriched electrolyte that can then be subjected electrochemical lead recovery.

This application claims priority to our U.S. Provisional application with the Ser. No. 62/881,743, filed Aug. 1, 2019, which is incorporated by reference herein.

### FIELD OF THE INVENTION

The present disclosure relates to compositions, methods, and devices to recover various metals from electrolytes, especially as it relates for example to removal and/or recovery of copper and silver from lead ion containing electrolytes.

### BACKGROUND OF THE INVENTION

The background description includes information that may be useful in understanding the present disclosure. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Various efforts have been made to move away from smelting operations and to use more environmentally friendly solutions in the recovery and refining of lead from lead acid batteries. For example, U.S. Pat. No. 4,927,510 (to Olper and Fracchia) teaches recovering in pure metal form substantially all lead from battery sludge after a desulfurization process. Unfortunately, such methods require use of a fluorine containing electrolyte, which is environmentally problematic. To overcome some of the difficulties associated with fluorine containing electrolyte, desulfurized lead active materials have been dissolved in methane sulfonic acid as described in U.S. Pat. No. 5,262,020 (to Masante and Serracane) and U.S. Pat. No. 5,520,794 (to Gernon). However, as lead sulfate is rather poorly soluble in methane sulfonic acid, upstream desulfurization is necessary and residual insoluble materials typically reduce the overall yield to an economically unattractive process. To improve at least some of the aspects associated with lead sulfate, oxygen and/or ferric methane sulfonate can be added as described in International Patent Application Publication No. WO 2014/076544 (to Fassbender et al), or mixed oxides can be produced as taught in International Patent Application Publication No. WO 2014/076547 (to Fassbender et al). However, despite the improved yield, several disadvantages nevertheless remain. Among other things, solvent reuse in these processes often requires additional effort, and residual sulfates are still lost as waste product. Moreover, during process upset conditions or power outage (which is not uncommon in electrolytic lead recovery), the plated metallic lead will dissolve back into the electrolyte in conventional electrolytic recovery operations, unless the cathode was removed and the lead peeled off, rendering batch operation at best problematic.

Most of the above mentioned problems have been overcome in an integrated process that desulfurizes lead paste and reduces lead dioxides before or after desulfurization and in which lead ionic species are generated that are soluble in an alkane sulfonic acid electrolyte as is described in WO 2016081030, and WO 2016183428. Advantageously, such processes allow for continuous production of lead with relatively high-purity on a moving cathode. However, as metals that are nobler than lead (e.g., copper, silver) are typically present in the electrolyte of such processes, co-plating of these metals will limit the degree of purity that can be achieved with such processes. Unfortunately, selective recovery of metals that are nobler than lead is often problematic as these metals are commonly present at very low concentrations compared to lead. For example, a typically lead electrolyte may have a lead ion concentration of 20-200 g/l, while silver and copper ions are present at about 5 mg/l and 8 mg/l, respectively.

Thus, even though systems and methods are known to recover lead from electrolytes, small quantities of more noble metals such as silver and/or copper may reduce the purity of electrochemically produced metallic lead. Therefore, there is still a need for improved systems that increase lead purity and/or recover valuable metals at low concentrations from a process electrolyte.

### SUMMARY OF THE INVENTION

The inventors have discovered various devices, systems, and methods that enable removal and/or recovery of valuable metals, and especially of copper and silver from electrolytes that comprise significant quantities of lead ions.

In one aspect of the inventive subject matter, the inventors contemplate a method of treating a lead-enriched electrolyte that includes a step of feeding the lead-enriched electrolyte into an electrochemical polishing reactor having an anode and a high-surface area cathode. In contemplated methods, the lead-enriched electrolyte comprises at least one other metal ion that has an electrode potential that is higher than that of lead (e.g., copper and/or a silver). In another step, a low current is applied to a high-surface area cathode to reduce the other metal ion on the high-surface area cathode to so produce a pre-treated lead-enriched electrolyte.

Most typically, lead ions in the pre-treated lead-enriched electrolyte can then be reduced in an electrochemical production reactor to produce metallic lead. In some embodiments, the lead-enriched electrolyte has a lead ion concentration of at least 20 g/L, or at least 50 g/L, or at least 100 g/L, while the lead-enriched electrolyte has a metal ion concentration of less than 10 mg/l of copper and/or silver.

With respect to the electrodes it is contemplated that the high-surface area cathode will comprises carbon felt, foamed glassy carbon, carbon cloth, exfoliated graphite, carbon nanotubes, or graphene. Preferably, the high-surface area cathode is configured as a flow-through cathode. Most typically, the anode comprises titanium or other suitable material. Most typically, for a 100 cm² cell, the low current is a current below 400 mA, or below 300 mA, or below 200 mA, while in preferred aspects the low current produces a current density of equal or less than 4 mA/cm², or equal or less than 3 mA/cm², or equal or less than 2 mA/cm². Viewed form a different perspective, control of the electrode potential is employed to preferentially reduce the more noble metal ions of choice in the presence of relatively high concentrations of a less noble metal.

In further aspects, the concentration of the at least one other metal ion in the pre-treated lead-enriched electrolyte is equal or less than 10 ppb, or equal or less than 5 ppb, or equal or less than 1 ppb. Additionally, it is contemplated that the step of feeding the lead-enriched electrolyte into the electrochemical polishing reactor can be concurrently performed with a step of reducing lead ions in the pre-treated lead-enriched electrolyte in an electrochemical production reactor to so continuously produce metallic lead. Most preferably, the lead electrochemically produced from the pre-treated lead-enriched electrolyte has a purity of at least 99.99%, or at least 99.999%, or at least 99.9999%, or at least 99.99999%.

Various objects, features, aspects, and advantages will become more apparent from the following detailed description of preferred embodiments, along with the accompanying drawing in which like numerals represent like components.

### BRIEF DESCRIPTION OF THE DRAWING

FIG. 1 schematically depicts half-cell potentials for selected ions with respect to reactions occurring at the cathode.

FIG. 2 schematically depicts an exemplary lab scale configuration of an electrolytic cell according to the inventive subject matter.

FIG. 3 is a photograph of an exemplary lab scale configuration of an electrolytic cell according to the inventive subject matter.

FIG. 4 is a graph depicting exemplary results for Ag/Cu concentration versus current in an electrolytic cell according to the inventive subject matter.

FIG. 5 is a graph depicting exemplary results for Ag/Cu recovery using an electrolytic cell according to the inventive subject matter.

FIG. 6 provides various calculations relevant to the methods presented herein.

### DETAILED DESCRIPTION

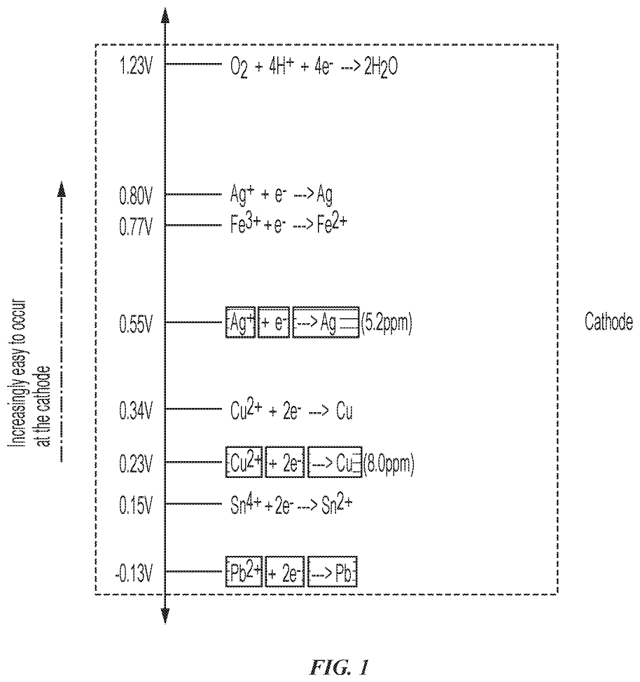

The inventors have now discovered that a lead ion containing electrolyte can be pre-treated to reduce the metal ion content for those metals that are more noble than lead in a given electrolyte (i.e., metals that have a more positive electrode potential in the given electrolyte). Thus, such pre-treated electrolyte will enable electrochemical production of metallic lead at very high purity. Moreover, removal of the metals that are more noble than lead will also allow for recovery of valuable commodities, and especially copper and silver. FIG. 1 exemplarily depicts half-cell potentials for selected ions with respect to their reactions occurring at the cathode.

For example, in one preferred aspect of the inventive subject matter, the lead-enriched electrolyte comprises an alkane sulfonic acid (preferably methane sulfonic acid) and lead ions are present in the electrolyte at a concentration of between about 20-200 g/L. Most typically, the lead-enriched electrolyte will further include copper ions at a concentration of about 5-10 mg/L and silver ions at a concentration of about 3-8 mg/L. The lead-enriched electrolyte is then fed into an electrochemical polishing reactor that includes an anode and a high-surface area cathode that is configured as a flow-through electrode, and copper and silver are plated onto the high-surface area cathode using a low current (e.g., less than 500 mA) at low current density (e.g., less than 5 mA/cm²). Of course, it should be appreciated that copper and silver can be pated separately, or together as is described in more detail below.

With respect to suitable electrochemical polishing reactors it is contemplated that the reactor is typically configured to allow for continuous processing of the lead-enriched electrolyte. Therefore, suitable electrochemical polishing reactors may be configured as a once flow-through reactor, or as a flow-through reactor with a surge tank from which the lead-enriched electrolyte is recirculated. In less preferred aspects, the electrochemical polishing reactor may also be configured to operate in batch fashion to pre-treat the lead-enriched electrolyte. Regardless of the particular configuration, it is typically preferred that the cathode in the electrochemical polishing reactor comprises a high-surface area (e.g., 0.2-0.8 m²/g) cathode. In most cases, such high surface area cathode will include (activated) carbon felt, graphite felt, foamed glassy carbon, exfoliated graphite, carbon nanotubes, and/or graphene, and will have a porosity to allow flow of the lead-enriched electrolyte through the cathode (most typically across the thickness of the cathode). Therefore, contemplated high-surface area cathodes may have a surface area of at least 0.1 m²/g, or at least 1.0 m²/g, or at least 10 m²/g, or at least 50 m²/g, or at least 100 m²/g, or at least 200 m²/g, at least 500 m²/g, at least 1,000 m²/g, or even higher. For example, suitable high-surface area cathodes will have a flow-through path with a minimum length (as measured between entry and exit of the electrolyte) of at least 1 mm, or at least 2 mm, or at least 3 mm, or at least 5 mm, or at least 10 mm, or at least 25 mm, or at least 50 mm, or even more. It is still further generally preferred that the high-surface area cathode will have a height and/or width that is at least 10 times, or at least 20 times, or at least 40 time, or at least 100 times the thickness of the high-surface area cathode. Thus, viewed from a different perspective, contemplated high-surface area cathodes will be generally configured as a thick sheet and the flow of the electrolyte will be across the thickness of the high-surface area cathode.

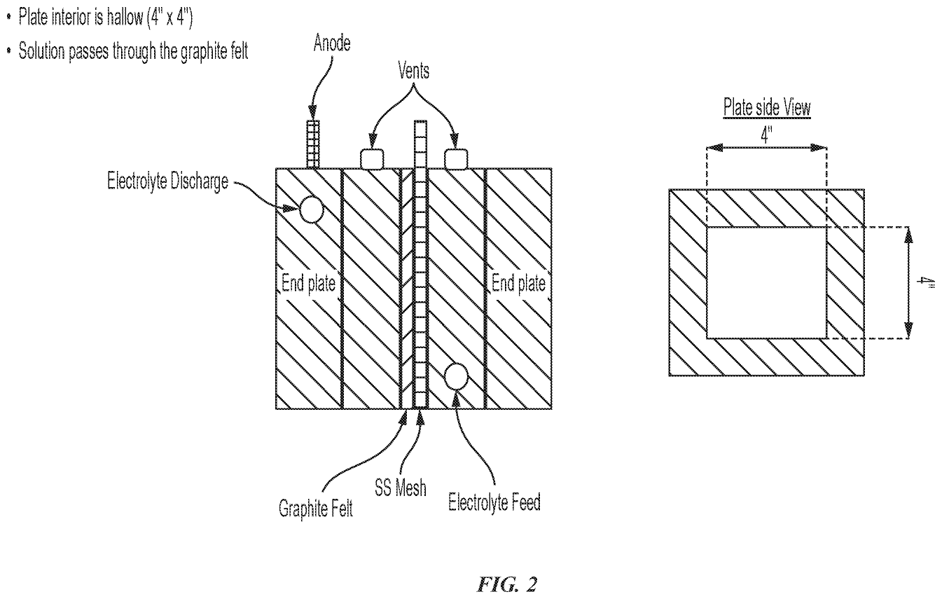

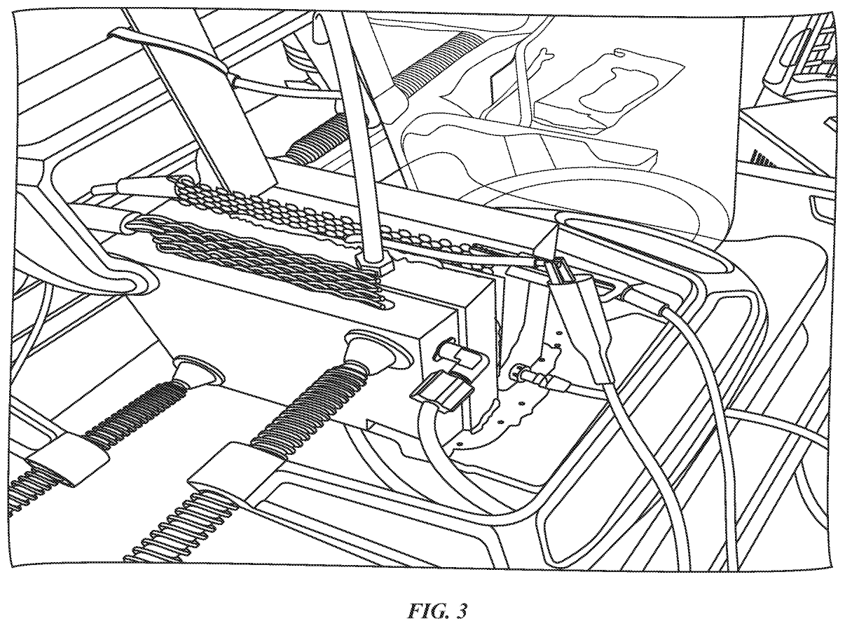

As will be readily appreciated, the carbon felt or other high surface area material may be coupled to a conductive carrier such as a stainless steel mesh. FIG. 2 depicts an exemplary schematic of an electrochemical polishing reactor having two end plates between which are disposed inlet and outlet with vents as well as a stainless steel mesh to which graphite felt is conductively attached. The outlet plate may further include an iridium coated titanium mesh anode. FIG. 3 is a photograph of a pilot cell according to FIG. 2 that was used in the experiments described in more detail further below.

Most typically, the polishing reactor will be configured such that at least 60%, or at least 70%, or at least 80%, or at least 90%, or at least 95%, or at least 98% of the copper and/or silver in the lead-enriched electrolyte are deposited on the flow through cathode at a flow rate that allows continuous lead recovery at a cathode in a downstream lead reduction reactor. Therefore, the polishing reactor may have multiple electrolytical cells (typically operated in parallel). However, in other embodiments, one or more polishing reactors may also be operated in a batch-wise manner to accommodate flow rates that are different from the flow rate needed to feed the lead reduction reactor(s).

During operation, particularly where relatively low currents are used at corresponding low current densities, the more noble metals such as copper and silver will deposit on and in the high-surface area cathode. Thus, depending on the particular operating conditions, metals can be (preferentially) deposited by controlling the current or co-deposited, and the particular electrode potential for the particular metal and electrolyte system will determine the type of deposition. However, as will be readily appreciated, the more noble metals will typically be co-deposited with metallic lead where the lead concentrations are significantly higher than the more noble metal. For example, where copper and silver ions are reduced to metallic copper and silver, lead will be co-deposited as well, especially where lead ions are present at a concentration of greater than 20 g/L, or greater than 50 g/L, or greater than 100 g/L.

Of course, it should be appreciated that the nature of the electrolyte may vary considerably, and that all known electrolytes are deemed appropriate for use herein, including those that comprise alkane sulfonic acid, sulfuric acid, fluoboric acid, or a strong base (e.g., KOH, NaOH, etc.). Moreover, suitable electrolytes may include various other ionic species and most typically metal ions encountered with lead acid battery recycling. Consequently, it is contemplated that the pre-treatment of the electrolyte may be implemented with any electrolytic process in which lead is recovered from lead acid battery recycling. Lead ions will generally be present in the electrolyte at a concentration of between 10-20 g/L, or between 20-50 g/L, or between 50-100 g/L, or between 100-200 g/L, or even higher. On the other hand, the more noble metals will generally be present at individual concentrations of equal or less than 1 g/L, or equal or less than 500 mg/L, or equal or less than 200 mg/L, or equal or less than 100 mg/L, or equal or less than 50 mg/L, or equal or less than 25 mg/L, or equal or less than 10 mg/L.

With respect to the electrochemical polishing reactor it is contemplated that the specific dimensions will typically be determined by the volume of the electrolyte that is to be processed and/or by the type of operation (e.g., once flow-through, recirculation, batch processing, etc.). For example, polishing reactors may be configured to have an electrolyte flow rate of between about 50-200 mL/min, or between about 200-500 mL/min, or between about 500-5,000 mL/min, or between about 5-50 L/min, and even higher. Consequently, the cathode working area may be between 50-200 cm², or between 200-2,000 cm², or between 2,000-20,000 cm², and even higher. Moreover, it should be noted that the electrochemical polishing reactor may have more than one high-surface area cathode, which may be serially arranged (to provide a first pre-treated electrolyte to a second cathode) or in parallel. Use of multiple cathodes is especially advantageous where continuous operation requires removal of one cathode while diverting flow of the electrolyte to another cathode.

Most typically, operation of the electrochemical polishing reactor will be continuous manner or at least to a point at which back pressure from metal build-up in the cathode will reach a predetermined level (or at which the high surface area is reduced by a predetermined degree). Most typically, and depending on the particular more noble metal, the current and current density will vary to at least some degree. However, it is generally preferred that the current and current density will be as practicably low as possible to preferentially deposit the more noble metal and to reduce lead formation on the cathode. Thus, preferred currents will in many cases be equal or less than 500 mA, or equal or less than 400 mA, or equal or less than 350 mA, or equal or less than 300 mA, or equal or less than 250 mA, or equal or less than 200 mA, or equal or less than 150 mA, and in some cases even lower. Consequently, current densities at the high surface area cathode will typically equal or less than 5 mA/cm², equal or less than 4 mA/cm², equal or less than 3.5 mA/cm², equal or less than 3 mA/cm², equal or less than 2.5 mA/cm², equal or less than 2 mA/cm², or even lower (with the density in mA/cm² calculated using external dimensions of the high surface material rather than actual electrode surface). Most typically, residual quantities of the non-lead metals in the lead-containing electrolyte will be below 500 ppb, or below 300 ppb, or below 200 ppb, or below 100 ppb, or below 50 ppb, or below 25 ppb, or below 10 ppb, or may even be below detection limit using standard detection methods well known in the art. Thus, the electrolyte may be substantially depleted (e.g., below 100 ppb or below 25 ppb) of one or more of the non-lead metals in the electrolyte.

In yet further contemplated aspects, one or more of the more noble metals may also be recovered using ion exchange processes. For example, where copper removal by ion exchange is desired, a copper selective chelating resin may be employed (e.g., DOWEX™ M4195). Use of such resin is typically upstream of the electrochemical polishing reactor. Similarly, silver ions may be removed using a silver selective ion exchange resin (e.g., Chelex-100). Such adsorptive methods will typically be implemented on-line such that the lead-enriched electrolyte can continuously flow through the resin and then into the electrochemical polishing reactor. On the other hand, the ion exchange resin may also be placed downstream of a polishing reactor to reduce breakthrough of copper and/or silver where reduction in the flow though cathode was terminated or interrupted.

Regardless of the particular manner of non-lead ion removal it is generally preferred that the metals will be recovered as value products. Most typically, the value products may be further purified as lead will be a major component of the recovered metals due to its overwhelming presence in the lead-enriched electrolyte. As lead has a very low melting point as compared to the other metals, lead can be removed from the other metals by any thermal method. Alternatively, lead may also be (electro)chemically dissolved from the cathode material into suitable electrolytes (e.g., sulfuric acid, fluoboric acid, or methane sulfonic acid).

In further contemplated aspects, it should be particularly recognized that the processes presented herein are especially suitable for solvent/electrolyte-based recycling processes of lead materials and especially lead battery recycling processes. Such recycling processes may have various components such as an upstream desulfurization of lead paste, treatment of lead paste (desulfurized or not) to remove or convert lead dioxide, thermal treatment of lead paste, and wash and/or drying steps. Exemplary processes suitable for integration with the electrolyte pre-treatment include those described in WO 2015/077227, WO 2016/081030, WO 2016/183428, and U.S. 62/860,928, all incorporated by reference herein. Thus, the inventors especially contemplate one or more polishing reactors as presented herein fluidly and upstream coupled to one or more lead reduction reactors, where the polishing reactor(s) and the lead reduction reactor(s) can be operated at the same time such that an electrolyte can flow from a polishing reactor to a lead reduction reactor.

Moreover, it should be appreciated that while the above description is predominantly focused on removal/recovery of silver and/or copper from a lead ion containing electrolyte, the devices and methods presented herein can also be applied more broadly to any situation where an electrolyte contains a more noble (electropositive) metal at a concentration that is lower (and in many cases substantially lower) than that of another less noble metal. In these cases, it should be appreciated that the combination of control of the electrode potential and use of a high-surface cathode (preferably flow-through cathode) will advantageously allow for preferential reduction of the more noble metal at the cathode in the presence of the less noble metal. Thus, and viewed from a different perspective, selected non-lead metals (e.g., silver) can be removed and reduced from a lead-containing electrolyte while other non-lead metals (e.g., copper) remain in the lead-containing electrolyte.

### Examples

The following examples are provided to illustrate aspects of the inventive subject matter and should not be construed to limit the invention in any way. Unless stated otherwise, the lead-enriched electrolyte was obtained from dissolving a desulfurized lead paste in methane sulfonic acid. In most cases, the lead ion concentration was between 20-200 mg/L and contained about 5.2 mg/L silver and about 8 mg/L copper.

The electrochemical polishing reactor was configured as a bench scale flow-through electrolyzer as exemplarily depicted in FIGS. 2 and 3. The anode material was iridium coated titanium mesh and the cathode was a stainless-steel mesh that was conductively coupled to graphite felt. The graphite felt had a working surface of 100 cm² used as a flow though cathode as shown in FIG. 2 using a flow rate of 100 mL/min. The lead-enriched electrolyte was sent through the cell in a single pass closed system for about 6-8 hours/day until back pressure from the metal build-up at the electrode restricted flow. Feed and discharge solutions were tested for copper and silver concentrations. Electrolytic recovery of the metals was performed at suitable currents using the considerations/parameters for reduction of ions to the corresponding metal as shown in Table 1. More specifically, Table 1 shows exemplary electrode potentials for reactions at the cathode, and Table 2 shows exemplary electrode potentials for reactions at the anode. Table 3 depicts cell potentials used for the exemplary pre-treatment reactions.

TABLE 1

| Reaction | Potential |
|---|---|
| O₂ + 4H⁺ + 4e⁻ ---> 2H₂O | Eₒ = 1.23 V |
| Ag⁺ + e⁻ ---> Ag | Eₒ = 0.80 V |
| Fe + e⁻ ---> Fe²⁺ | Eₒ = 0.77 V |
| Cu²⁺ + 2e⁻ ---> Cu | Eₒ = 0.34 V |
| Sn⁴⁺ + 2e⁻ ---> Sn²⁺ | Eₒ = 0.15 V |
| Pb²⁺ + 2e⁻ ---> Pb | Eₒ = −0.13 V |

TABLE 2

| Reaction | Potential |
|---|---|
| Pb²⁺ + 2H₂O ---> PbO₂ + 4H⁺ + 2e⁻ | Eₒ = −1.46 V |
| 2H₂O ---> O₂ + 4H⁺ + 4e⁻ | Eₒ = −1.23 V |

TABLE 3

| Reaction | Concentration | Working Potential |
|---|---|---|
| Ag⁺ + e⁻ ---> Ag | Ag = 5.2 ppm | E = 0.55 V |
| Cu²⁺ + 2e⁻ ---> Cu | Cu = 8.0 ppm | E = 0.23 V |

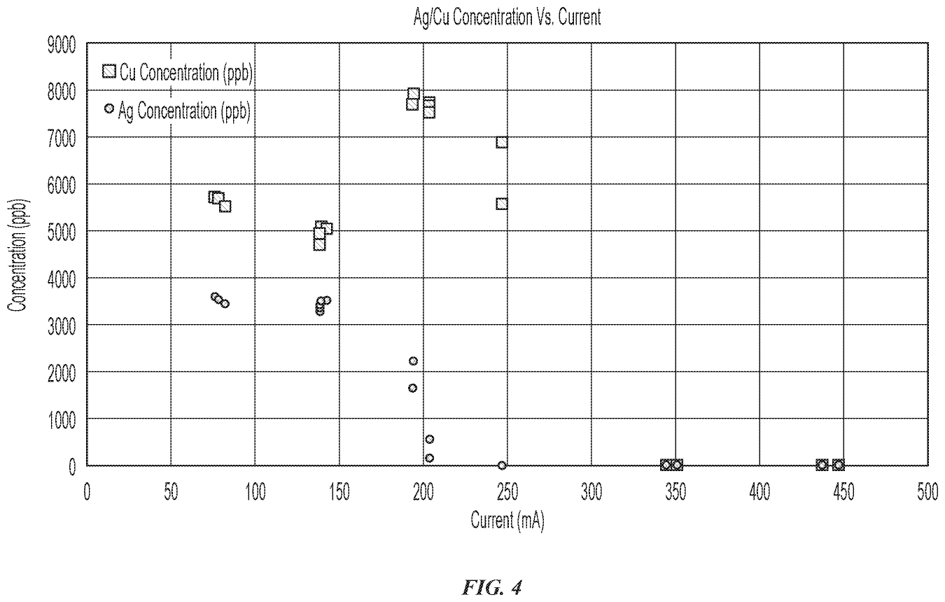

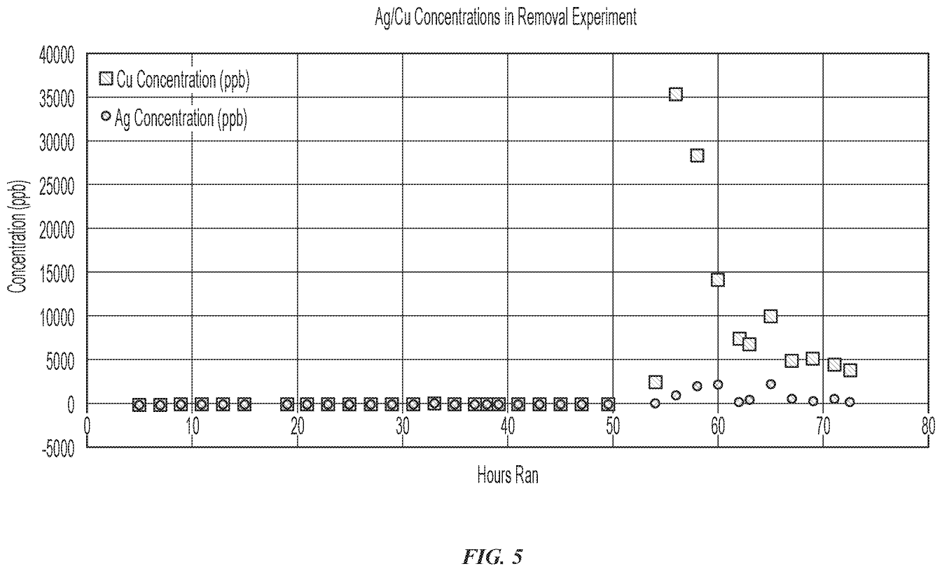

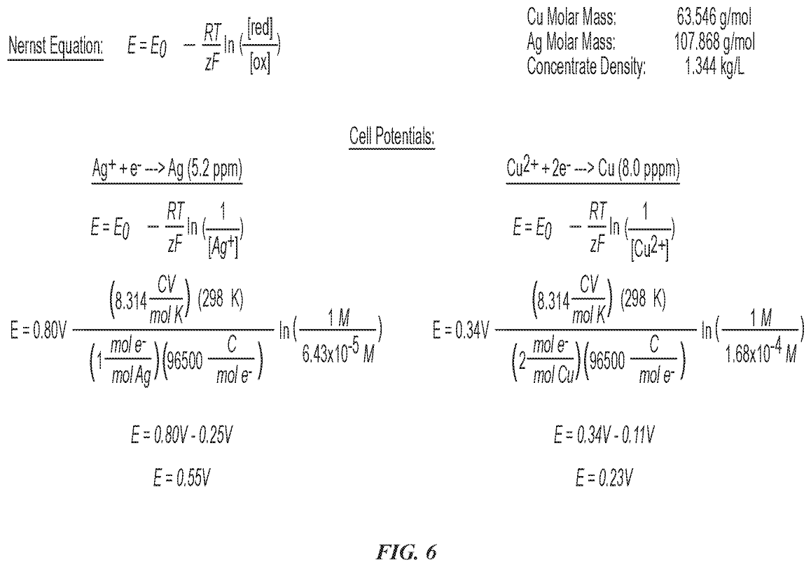

As can be seen from the results in FIG. 4, silver selectively plated at a current of 200 mA (and a current density of about 2.0 mA/cm²) and copper was fully recovered at a current of about 350 mA (and a current density of about 3.5 mA/cm²). When looking at the time course or recovery, copper and silver levels fell below the limit of detection for the first 53 hours of run time using a solution that contained about 5200 ppb silver ions and about 8000 ppb copper ions in the presence of lead ions at about 200 g/L. After 55 hours run time, copper concentration increased significantly in the effluent while the silver concentration remained at or below the feed concentration as can be seen from FIG. 5. When analyzing the metals in the cathode, co-deposition of lead, coper, and silver was observed, with about 80% of the metals being lead, 12% of the metals being copper, and 8% of the metals being silver. FIG. 6 provides further equations and calculations used herein. Finally, it should be noted that the processes herein are suitable not only for lead acid battery recycling, but for all processes in primary lead production and lead plating.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the full scope of the present disclosure and does not pose a limitation on the scope of the invention otherwise claimed. No language in the specification should be construed as indicating any non-claimed element essential to the practice of the claimed invention.

It should be apparent to those skilled in the art that many more modifications besides those already described are possible without departing from the full scope of the concepts disclosed herein. The disclosed subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A method of treating an electrolyte, comprising:
feeding the electrolyte into an electrochemical polishing reactor having an anode and a high-surface area cathode;
wherein the electrolyte comprises a first metal ion and a second metal ion, wherein the first metal is more noble than the second metal, and wherein the first metal ion is present in the electrolyte at a lower concentration than the second metal ion, and wherein the second metal ion is a lead ion; and
controlling an electrode potential at the high-surface area cathode to reduce the first metal ion in the presence of the second metal ion to so produce a pre-treated electrolyte that comprises the second metal and that is substantially depleted of the first metal.

2. The method of claim 1 wherein the high-surface area cathode is configured as a flow-through cathode.

3-6. (canceled)

7. The method of claim 1 wherein the high-surface area cathode comprises carbon felt, woven or non-woven carbon cloth, graphite felt, foamed glassy carbon, exfoliated graphite, carbon nanotubes, or graphene, and wherein the high-surface area cathode is optionally is configured as a flow-through cathode.

8. The method of claim 1 wherein the first metal is silver or copper.

9. The method of claim 1 wherein the first metal concentration in the electrolyte is equal or less than 10 mg/ml, and wherein the second metal concentration in the is electrolyte is at least 20 g/L.

10. The method of claim 1 further comprising a step of reducing the second metal ion in the pre-treated electrolyte in an electrochemical production reactor.

11. A method of treating a lead-enriched electrolyte, comprising:
feeding the lead-enriched electrolyte into an electrochemical polishing reactor having an anode and a high-surface area cathode that is configured as a flow-through cathode;
wherein the lead-enriched electrolyte comprises at least one other metal ion that has an electrode potential that is higher than that of lead; and
applying a low current or controlling electrode potential to the high-surface area cathode to reduce the other metal ion on the high-surface area cathode to so produce a pre-treated lead-enriched electrolyte and a cathode onto which the other metal is plated.

12. The method of claim 11 further comprising a step of reducing lead ions in the pre-treated lead-enriched electrolyte in an electrochemical production reactor to produce metallic lead.

13. The method of claim 11 wherein the lead-enriched electrolyte has a lead ion concentration of at least 20 g/L, and wherein the lead-enriched electrolyte has a metal ion concentration of less than 10 mg/L.

14. The method of claim 11 wherein the lead-enriched electrolyte has a lead ion concentration of at least 50 g/L, and wherein the lead-enriched electrolyte has a metal ion concentration of less than 10 mg/L.

15. The method of claim 11 wherein the lead-enriched electrolyte has a lead ion concentration of at least 100 g/L, and wherein the lead-enriched electrolyte has a metal ion concentration of less than 10 mg/L.

16. The method of claim 11 wherein the high-surface area cathode comprises carbon felt, woven or non-woven carbon cloth, graphite felt, foamed glassy carbon, exfoliated graphite, carbon nanotubes, or graphene.

17. (canceled)

18. The method of claim 11 wherein the anode comprises titanium coated with RuO₂ or IrO₂.

19. The method of claim 11 wherein the at least one other metal ion is a copper ion or a silver ion.

20. The method of claim 11 wherein the low current produces a current density of equal or less than 4 mA/cm².

21-22. (canceled)

23. The method of claim 11 wherein the concentration of the at least one other metal ion in the pre-treated lead-enriched electrolyte is equal or less than 10 ppb.

24. The method of claim 11 wherein the concentration of the at least one other metal ion in the pre-treated lead-enriched electrolyte is equal or less than 5 ppb.

25. The method of claim 11 wherein the concentration of the at least one other metal ion in the pre-treated lead-enriched electrolyte is below detection limit.

26. The method of claim 11 wherein the step of feeding the lead-enriched electrolyte into the electrochemical polishing reactor is concurrently performed with a step of reducing lead ions in the pre-treated lead-enriched electrolyte in an electrochemical production reactor to produce metallic lead.

27. The method of claim 26 wherein lead electrochemically produced from the pre-treated lead-enriched electrolyte has a purity of at least 99.99%.
